(19) United States
(12) Patent Application Publication
(10) Pub. No.: US 2007/0060148 A1
(43) Pub. Date: Mar. 15, 2007

(54) Packet scheduler

(75) Inventor: Gregory Manuel, Bruxelles (BE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/492,908

(22) Filed: Jul. 26, 2006

(30) Foreign Application Priority Data
Aug. 8, 2005 (GB) 0516296.1

(51) Int. Cl. H04Q 7/20

(52) U.S. Cl. 455/445

(57) ABSTRACT

A packet scheduler for scheduling transmission over a wireless communications high speed downlink connection of at least one data packet addressed to at least one user equipment. The data packets are stored in a buffer. The packet scheduler includes a processor arranged to determine from the buffer at least one data packet parameter relating to the stored data addressed to each user equipment, and further arranged to determine and vary at least one criteria parameter value. A comparator is configured to compare each data packet parameter against a corresponding at least one criteria parameter value, and further configured to compare each data packet parameter against a corresponding at least one varied criteria parameter value, and a data selector configured to select at least one data packet for scheduling based on the output from the comparator.

### BACKGROUND TO THE INVENTION

1. Field of the Invention

This invention relates to adjusting packet scheduling in communication systems and in particular, but not exclusively, it is especially applicable to packet scheduling in high speed downlink packet access (HSDPA) link adaptation mechanism for WCDMA communication systems.

2. Description of the Related Art

As is known in the field a further development of the wideband code division multiple access (WCDMA)/universal mobile telecommunications system (UMTS) communication system defined by the 3rd Generation Partnership Project 3GPP organization, was the definition of the system known as high speed downlink packet access (HSDPA). HSDPA operates as a time shared communications channel which provides the potential for high peak data rates as well as the possibility for having a high spectral efficiency.

Current 3GPP HSDPA standards (e.g. 3GPP TS 25.858) define a HS-DSCH channel (high speed downlink shared channel), which is a downlink transport channel shared by several user equipment units. The HS-DSCH is associated with one downlink DPCH (downlink dedicated physical channel), and one or several shared control channels (HS-SCCH). The HS-DSCH can be transmitted over the entire cell or over only part of the cell using for example beam-forming antennas.

HSDPA improves system capacity and increases user data rates in the downlink, in other words for transmission of data from a radio base station (RBS) which in a UMTS system is also known as a node B server (and in the GSM by the term base transceiver station BTS) to the user equipment.

This improved performance is based on three aspects. The first aspect is the use of adaptive modulation and coding.

In HSDPA, the link adaptation entity in the radio base station (Node-B server) tries to adapt to the current channel conditions of a certain user equipment (or user terminal) by selecting the highest possible modulation and coding scheme keeping the frame error probability below a certain threshold. For that purpose, the user equipment periodically sends channel quality feedback reports to the respective serving RBS, which indicate the recommended transmission format for the next transmission time interval (TTI), including the recommended transport block size, the recommended number of codes and the supported modulation scheme as well as a possible power offset. The reported channel quality indicator (CQI) value is determined on the basis of measurements of a common pilot channel. In a typical implementation it is a pointer to an index in one of the tables specified in the document “3GPP TS 25.214—Physical Layer Procedures (FDD)” that define the possible transmission format combinations (as mentioned above) for different categories of user equipment (UE).

The second aspect is the provision of fast retransmissions with soft combining and incremental redundancy, so that should link errors occur the user equipment rapidly requests retransmission of the data packets. Whereas the standard WCDMA network specifies that the requests are processed by the radio network controller (RNC), in HSDPA the request is processed by the RBS. Furthermore the use of incremental redundancy, allows the selection of correctly transmitted bits from the original transmission and retransmission in order to minimize the need for further repeat requests when multiple errors occur in transmitted signals.

The third aspect of HSDPA is fast scheduling in the RBS. This is where data to be transmitted to the user equipment is buffered within the RBS prior to transmission and the RBS using a selection criteria selects some of the packets to be transmitted based on information about the channel quality, user equipment capability, the quality of service class and power/code availability. A commonly used scheduler is the so-called proportional fair (P-FR) scheduler. The basic P-FR scheduler exploits multi-user diversity by scheduling users only when they observe good channel conditions (“on top of their fades”), thus yielding a good compromise between maximizing the system capacity and achieving fairness among different users. Generally, the actual scheduling decision is based on certain scheduling metrics, which are re-calculated before every scheduling instant, and normally result simply in the user with the highest metric being served. For the P-FR scheduler, this metric is usually the ratio between the data rate that is considered to be achievable for a particular user in the next TTI and the average long-term throughput of that user.

A further known scheduler is the round robin scheduler. In such a system multi-user diversity is exploited by selecting the first few users of a scheduling candidate set, scheduling those selected users for transmission and moving the selected users to the rear of the scheduling candidate list to allow the remaining candidates priority for the following TTI.

Such scheduling systems as described above are optimised for scheduling high bit rate communications which are generally delay tolerant. However where the channels use low bit rates which only have low delay tolerance such as occur when for example the system is used for voice over internet protocol (VOIP) communications or a mix of high and low delay tolerance channels where data and voice over IP services are being provided by the same system these systems do not perform well in terms of spectral efficiency and therefore capacity.

One solution to the problem of low latency tolerant services was discussed by Bang Wang et al in the conference paper “VoIP Performance in HSDPA Simulation Study”, VTC 2005 Spring, 30 May-1 Jun. 2005, Stockholm, Sweden.

The solutions suggested by this paper although addressing the problem of optimizing spectral efficiency of HSDPA for low bit rates services, do so at the cost of introducing higher latency delays. There is therefore the unaddressed problem of providing low latency delay links whilst reducing the spectral efficiency by as small as an amount as possible.

### SUMMARY OF THE INVENTION

It is an aim of the invention, and embodiments thereof, to provide an improvement to mobile access systems which at least partially addresses the problem disclosed above.

There is provided according to embodiments of the invention a packet scheduler for scheduling transmission over a wireless communications high speed downlink connection of at least one data packet addressed to at least one user equipment, the packet scheduler comprising: a processor arranged to determine at least one data packet parameter relating to the data addressed to each user equipment, and further arranged to determine and vary at least one threshold value associated with at least one data packet parameter; a comparator arranged to perform a first iteration to compare each data packet parameter with an associated threshold value; and further arranged to perform at least one further iteration to compare each data packet parameter with an associated varied threshold value; and a data selector arranged to select at least one data packet for scheduling based on the output from the comparator.

The at least one data packet parameter relating to the stored data addressed to each user equipment may be at least one of: a number of stored packets awaiting transmission to each user equipment; a delay time since receiving the first stored packet awaiting transmission to each user equipment; and whether any of the stored packets awaiting transmission to each user equipment are pending retransmission packets.

The at least one threshold value may be at least one of; a minimum number of stored packets; a maximum delay time; and any pending retransmission packets.

The comparator may be arranged to provide an output if the number of stored packets awaiting transmission to each user equipment is greater to or equal to the minimum number of stored packets.

The comparator may be further arranged to provide an output if the stored packets awaiting transmission to each user equipment contain any pending retransmission packets.

The processor may be arranged to vary the value of the minimum number of stored packets.

A radio base station may comprise a packet scheduler as featured above.

The wireless communications high speed downlink connection may be a wideband code division multiplexing high speed down-link packet access communications (WCDMA HSPDA) system.

The data packets may be Voice over Internet Protocol (VoIP) packets.

According to a second aspect of the present invention there is provided a method of performing a packet scheduling transmission over a wireless communications high speed downlink connection of at least one data packet addressed to at least one user equipment, the method comprising the steps of: receiving at least one data packet addressed to at least one user equipment; determining at least one data packet parameter relating to the stored data addressed to each user equipment; further determining at least one threshold, the threshold associated with the at least one data packet parameter; varying at least one of the at least one threshold; comparing in a first iteration each data packet parameter against the associated threshold; further comparing in a further iteration each data packet parameter against the associated varied threshold; and selecting at least one data packet for scheduling based on the result of the first or further iteration of the comparing step.

The at least one data packet parameter relating to the stored data addressed to each user equipment may be at least one of: a number of stored packets awaiting transmission to each user equipment; a delay time since receiving the first stored packet awaiting transmission to each user equipment; and whether any of the stored packets awaiting transmission to each user equipment are pending retransmission packets.

The at least one threshold may be at least one of; a minimum number of stored packets; a maximum delay time; and any pending retransmission packets.

The step of comparing may comprise the step of outputting a value indicating the data packets to be selected if the number of stored packets awaiting transmission to each user equipment is greater to or equal to the minimum number of stored packets.

The first or further iteration of comparing may further comprise the step of outputting a value indicating the data packet to be selected if the stored packets awaiting transmission to each user equipment contain any pending retransmission packets.

The step of varying at least one of the at least one threshold may comprise the step of varying the value of the minimum number of stored packets.

The wireless communications high speed downlink connection may be a wideband code division multiplexing high speed down-link packet access communications (WCDMA HSPDA) system.

The data packets may be Voice over Internet Protocol (VoIP) packets.

A communications system may comprise a packet scheduler as featured above.

According to a third aspect of the present invention there is provided a computer program product arranged to carry out the method for performing a packet scheduling transmission over a wireless communications high speed downlink connection of at least one data packet addressed to at least one user equipment, the method comprising the steps of: receiving at least one data packet addressed to at least one user equipment; determining at least one data packet parameter relating to the stored data addressed to each user equipment; further determining at least one threshold, the threshold associated with the at least one data packet parameter; varying at least one of the at least one threshold; comparing in a first iteration each data packet parameter against the associated threshold; further comparing in a further iteration each data packet parameter against the associated varied threshold; and selecting at least one data packet for scheduling based on the result of the first or further iteration of the comparing step.

### BRIEF DESCRIPTION OF THE FIGURES

The invention is described by way of example only with reference to the accompanying figures in which

FIG. 1 shows a schematic view of a communications system within which embodiments of the present invention can be implemented;

FIG. 2 shows a flow diagram showing the steps performed in a first embodiment of the present invention;

FIG. 3 shows a table showing a worked example and the results from performing the steps as shown in FIG. 2 on a simulated set of variables;

FIG. 4 shows a table showing a worked example and the results from performing a prior art method using the same simulated set of variables used in FIG. 3; and

FIG. 5 shows a table showing a further worked example and results from performing a further prior art method using the same simulated set of variables used in FIGS. 3 and 4.

### DESCRIPTION OF THE PREFERRED EMBODIMENTS

The invention is described herein by way of example with reference to a number of embodiments. The invention is described in the context of a cellular communications system and specifically to a HSDPA WCDMA/UMTS communications system. It is however understood that the invention may equally be capable of being implemented in any communications system which implements scheduling of data packets especially those which need to address the problem of latency and spectral efficiency in transmission of data packets.

Furthermore although the following examples are described by relation to a communications system operating a Voice over Internet Protocol service, it would be appreciated that the embodiments of the present invention would be capable of producing similar advantages for other communications systems operating similar systems requiring high spectral efficiency in low packet delay tolerant services.

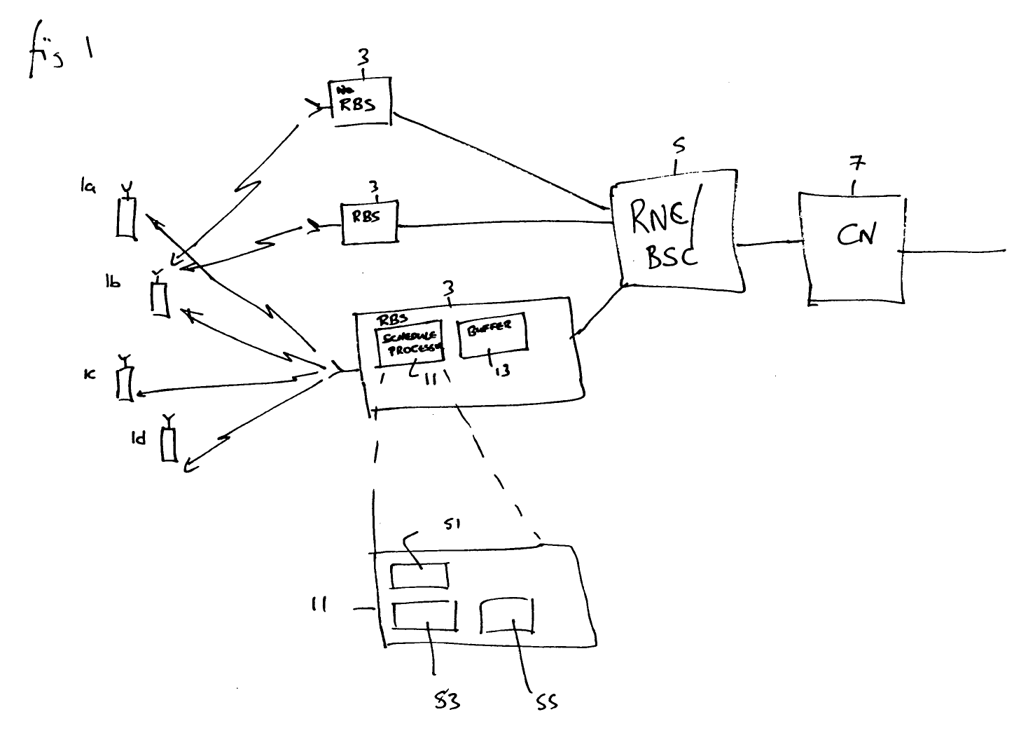

FIG. 1 shows a schematic view of a communications system within which the embodiments of the present invention can be implemented. The system comprises at least one user equipment (UE) 1. User equipment 1 can be for example a mobile telephone, but could also be for example a communication capable laptop, personal digital assistant, or any other suitable device.

User equipment 1 communicates wirelessly by radio with a series of radio base stations (RBS) 3. Each user equipment 1 is arranged to be able to communicate to more than one RBS 3 and similarly each RBS 3 is arranged to be capable of communicating to more than one UE 1. The RBS 3 further communicates with a radio network controller (RNC) 5 (which is also known in the GSM standard as a Base station controller (BSC)). The RNC 5 can further communicate to a core network (CN) 7. The CN 7 can further communicate with other networks, for example further public land mobile networks (PLMNs) or to the network of computers known as the ‘Internet’.

Each RBS 3 further comprises a scheduler processor 11 and a packet buffer 13. The packet buffer 13 receives packets to be transmitted to a UE 1 prior to transmission to the UE 1 identified by the packet. The packet buffer 13 is arranged to be divided into buffer segments, wherein each buffer segment is arranged to store packets addressed to specific user equipment 1 currently being serviced by the RBS 3.

Any buffer segment with more than one outstanding packet is defined as being a member of a scheduling candidate set (SCS). The SCS list is passed to the scheduler 11 for processing in order to determine which packets are to be transmitted over the high speed downlink shared channel during the next transmission time interval (TTI).

The scheduler itself comprises a processor 51, a comparator 53, and a scheduling data selector 55.

The processor 51 which in a first embodiment of the present invention determines parameter values for each of the buffer segments (i.e. a parameter for data packets addressed to each UE serviced by RBS). These three parameters are: Mpkts—or the number of unsent packets buffered in the buffer; Dpkts—the delay time or the time since the oldest unsent packet was buffered in the buffer; and Retrx—a flag indicating whether any of the stored data packets is a pending retransmission.

Furthermore the processor 51 determines a series of criteria parameter values. These criteria parameter values are values related to the parameter values determined for each of the buffer segments. Thus for example the criteria parameter value corresponding to the parameter relating to the number of unsent packets, Mpkts, can have a criteria parameter value of 4, a parameter relating to the delay time, Dpkts, of 80 ms, and a parameter relating to the stored packet is a pending retransmission packet of ‘yes’ or ‘1’. The processor is further able to modify or vary the value of these criteria parameter values. The action and consequences of varying these criteria parameter values is discussed in detail with regards to the operation of embodiments of the invention.

The processor 51 also monitors the available resources in the next TTI. In receiving the list of selected buffer segments and knowing the resources required to transmit the unsent packets in the buffer segments to the UE addressed then the currently scheduled resources can be subtracted from the known resources for the next TTI to calculate the remaining available resources for the next TTI.

The comparator 53 receives both the values of the criteria parameters and the parameters determined for each of the buffer segments. The comparator produces an output identifying the buffer segment containing data packets addressed to a UE where the data packet parameters are within the criteria parameter values. Thus for example if the active criteria parameters are only those corresponding to the Mpkts and Retrx parameters and the values of which were 4 and ‘yes’ respectively, then the comparator would output values indicating buffer segments containing data packets addressed to a UE where the number of unsent packets was equal to or greater than 4, or if there were any UE with pending retransmission packets.

The scheduling data selector 55 is connected to the comparator and on receiving an output value, then selects the data scheduled to be transmitted in the next TTI.

The application of these values is described in further detail hereafter.

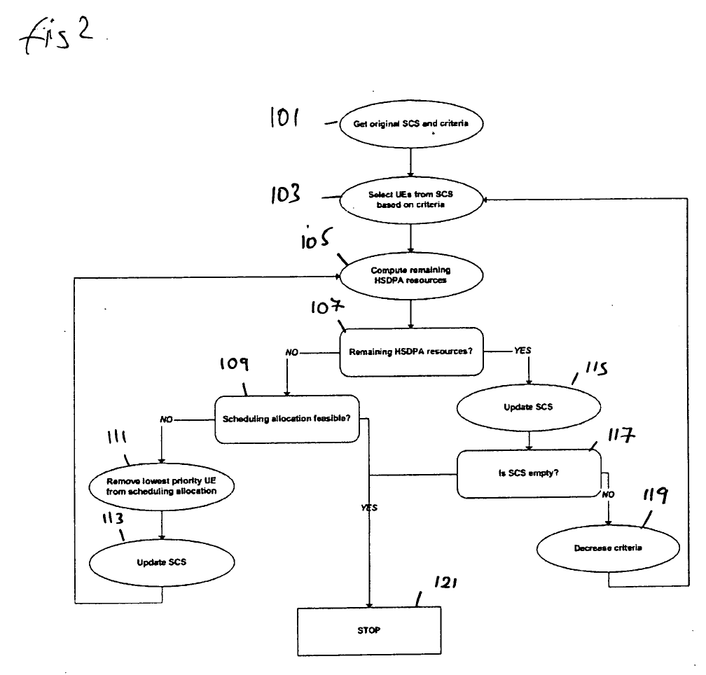

FIG. 2 shows a flow diagram showing a method carried out by the first embodiment of the present invention. In this embodiment the active criteria parameters are those related to the number of unsent packets per buffer segment (Mpkts) and whether each buffer segment contains a pending retransmission packet (Retrx).

In the first step 101, the scheduler 11 processor 51 receives the original SCS list and determines from this list of values any required data parameter values. The SCS list can in embodiments of the present invention be further listed or ordered in order of priority using a priority metric as known in the art. Examples of priority metrics are proportional fair or round robin systems and are not discussed in further detail.

Furthermore the scheduler 11 processor 51 determines an initial value for the criteria parameter value corresponding to Mpkts. This initial value can be determined using known modelling of the data used in the planned service or can be estimated by performing simulations or measuring real data.

In the next step 103, the scheduler 11 comparator 53 compares parameter values and the data selector 55 selects UE candidates from the SCS list based on the results of the comparator output. These selected UE candidates are UE candidates which are scheduled for transmission for the next TTI.

In the following step 105, the scheduler 11 processor 51 then calculates the remaining HSDPA resources for the next TTI after calculating the total resources used by the selected UE candidates. The result of this calculation is carried to the next step.

In the next step 107, the scheduler 11 processor 51 determines if there are any HSDPA resources remaining. If there is no remaining resource in the next scheduled TTI then the method passes to step 109, else the method passes to step 115.

In step 109 the scheduler performs a check to determine whether the currently scheduled selected packets can be feasibly transmitted in the next TTI. For example the number of selected users may be greater than the maximum allowed code-multiplexed users per TTI and therefore this selection is not feasible. If the scheduling for the next TTI is feasible the method passes to step 121, i.e. the scheduling stops for the next TTI.

If the scheduling for the next TTI is not feasible then the method follows a loop which restores the transmission feasibility of the selected candidates. The method therefore passes to step 111. In step 111, the scheduler compares the selected UE candidates against the priority metric associated with each SCS candidate as described with respect to step 101. The lowest priority UE candidate from the scheduled list of candidates is removed from the scheduling allocation.

In step 113, which follows step 111, the SCS is then updated following the removal of the candidate from the selected SCS list. In this step although the lowest priority UE candidate is removed from the scheduling allocation the updated SCS list removes all of the previously selected candidates, even if they are removed from the selected list by step 111. The method then passes back to step 105, where the scheduler 11 calculates the remaining HSDPA resources for the next TTI.

If the scheduler 11 determines in step 107 that there is remaining HSDPA resource in the next scheduled TTI then in step 115, the scheduler updates the SCS, having thus removed the selected SCS UE values.

In the step after 115, the scheduler examines the updated SCS and determines if the SCS list empty, in other words are there any remaining unsent and unscheduled packets remaining. If the list is empty and therefore all unsent packets have been scheduled in the next TTI the method proceeds to step 121, in other words the scheduling process for the next TTI stops.

If there are still values within the SCS when checked in step 117, the method passes to step 119. In step 119 the scheduler decreases at least one of the parameter values used in the criteria tests. After updating this at least one parameter value the method passes back to step 103, where a further set of criteria tests are carried out on the remaining SCS list candidates using the updated parameter values. In this first embodiment of the present invention the parameter value which is reduced is the number of packets unsent (Mpkts). This is decreased by a single value on each iteration of this step. Thus if the original parameter value required to pass the criteria test is 4 then it is reduced to 3 on the first action of step 119, 2 on the second action of step 119 and 1 on the third action of step 119. As would be understood by the person skilled in the art on setting the parameter value at 1 then any SCS candidate with an unsent packet would be selected by the criteria selection.

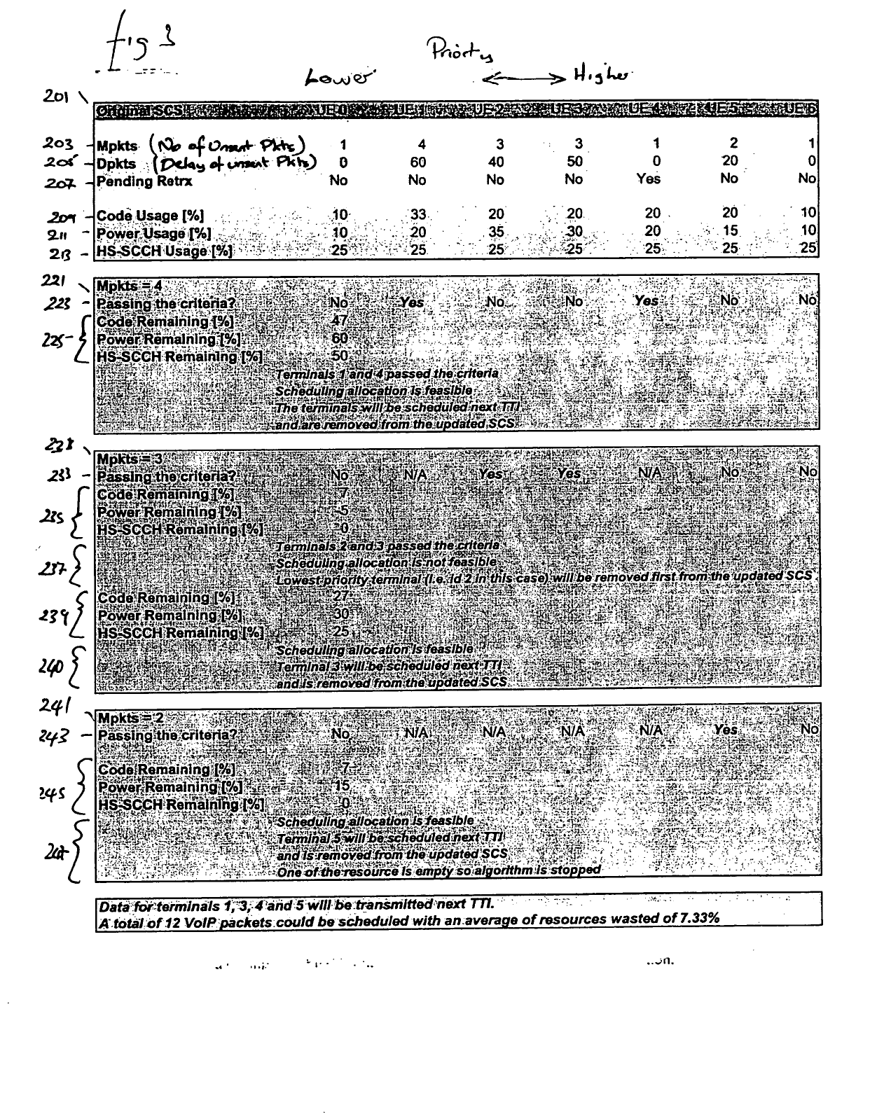

In order to further show the operation of the method according to this embodiment of the present invention FIG. 3 shows an example describing the operation of the scheduler 11 performing the method as described above.

The first part 201 of the table of FIG. 3, shows a SCS list as presented by the action of step 101. The list contains the values representing the buffer segments containing unsent packets addressed to seven user equipment terminals UE0 to UE6. Furthermore in the example described hereafter the list is arranged in order of priority as defined by a priority metric so that UE6 has the highest priority and UE0 the lowest priority according to a calculated priority metric. The operation of priority metrics are well known in the art and are not described hereafter.

The first part 201 first row 203 of the table shows the number of unsent packets associated with each UE. Thus UE0, UE4 and UE6 each have one packet outstanding, UE5 two packets outstanding, UE2 and UE3 three packets outstanding and UE1 four packets outstanding.

The second row 205 shows the delay time in milliseconds (ms) since the time of receipt in the buffer segment associated with each UE from the earliest unsent packet in each segment. The delay experienced by unsent packets addressed to UE0, UE4 and UE6 is 0 ms, UE5 20 ms, UE2 40 ms, UE3 50 ms, and UE1 60 ms.

The third row 207 shows if there are any outstanding packets to be retransmitted. Typically packets are retransmitted if there was an error in the original transmission. For such reasons it is therefore important to retransmit the packets as soon as possible to prevent the missing packet from delaying the processing of the data stream. In the example shown in FIG. 3 the packet awaiting transmission to UE4 is a packet awaiting retransmission whereas the other UE addressed packets are not awaiting retransmission.

The fourth 209, fifth 211 and sixth 213 rows describe the percentage usage for code, power, and HS-SCCH capacity respectively that transmitting to each of the user equipments would require if scheduled. Thus transmissions to UE0 would require 10% of the available codes, 10% of the available power and 25% of the HS-SCCH capacity if transmission to UE0 was scheduled. UE1 would require 33% of the available codes, 20% of the available power and 25% of the HS-SCCH capacity. UE2 would require 20% of the available codes, 35% of the available power and 25% of the HS-SCCH capacity. UE3 would require 20% of the available codes, 30% of the available power and 25% of the HS-SCCH capacity. UE4 would require 20% of the available codes, 20% of the available power and 25% of the HS-SCCH capacity. UE5 would require 20% of the available codes, 15% of the available power and 25% of the HS-SCCH capacity. UE6 would require 10% of the available codes, 10% of the available power and 25% of the HS-SCCH capacity.

The second part 221 of the table of FIG. 3 shows the results of a first iteration of the method of the first embodiment of the present invention to the above values.

If the criteria selected are to select the SCS candidate if the number of unsent packets (Mpkts) is equal or more than 4 or if any of the unsent packets are pending retransmission packets then as shown in row 2 of the second part the packets addressed to UE1 and UE4 pass the criteria and will be selected according to step 103.

In the following step of 105 the scheduler computes the remaining HSDPA resources. As is shown in the rows 225 by adding up the values of the selected columns of the first part of the table and subtracting this amount from the available 100% capacities, the remaining code capacity is 47%, the remaining power capacity is 60%, and the remaining HS-SCCH capacity is 50%.

As there are therefore remaining resources available then the method passes to step 115 where the values associated with UE1 and UE4 are removed from the SCS list. Furthermore as the SCS list still contains elements the method passes to step 119 from step 117.

As described above the parameter value used in the criteria test would be decreased by a value of 1. Thus as the method passes back to step 103 for a second time the criteria for selection from the SCS list is now if the number of unsent packets if equal to or more than 3 or if any of the unsent packets are pending retransmission packets.

The third part of the table of FIG. 3 shows the results of this second iteration of the method of the first embodiment of the present invention. The result of the second iteration step 103 as shown in row 233 of the table is that UE2 and UE3 now pass the criteria test and are selected.

The result of the second iteration of the step 105, as shown in rows 235, is that the remaining HSDPA resources produces a remaining code capacity of 7%, remaining power capacity of −5% and remaining HS-SCCH capacity of 0%.

The scheduler in the second iteration step 107 therefore determines that there is at least one resource element which has no remaining capacity, i.e. the HS-SCCH capacity is at its limit. Therefore the method passes to step 109 whereby the scheduler determines if the scheduling allocation is feasible.

With the figures as calculated above although the scheduling allocation is feasible in that the number of codes used is within the capacity, the power used by the current selection exceeds the allowed power capacity rating and therefore the scheduling selection or allocation is not feasible and the method follows an inner loop to restore the selection to a feasible transmission selection.

This inner loop passes to step 111, where the lowest priority UE candidate is removed from the selected scheduling allocation. In this example the lowest priority UE is UE2. The SCS is updated in step 113 and the method is passed back to step 105 where the scheduler 11 recalculates the remaining HSDPA resources after the removal of the UE candidate from the selected list as shown in rows 239. In this example the result of the step 105 at this point (when the selected UE candidate list is UE1, UE 3 and UE4) computes the remaining code capacity of 27%, remaining power capacity of 30% and remaining HS-SCCH capacity of 25%.

The method at step 107 at this point determines that there are remaining HSDPA resources to be used and this time the method passes to steps 115, 117 and 119 as shown in row 240. At step 119 the parameter value is once again decreased by a value of 1. Thus as the method passes back to step 103 for a third time the criteria for selection from the SCS list is now if the number of unsent packets if equal to or more than 2 or if any of the unsent packets are pending retransmission packets.

The third part 241 of the table of FIG. 3 shows the third iteration of the method of the first embodiment of the present invention. The result of the third iteration step 103 as shown in row 243 of the table is that UE5 now passes the criteria test and is selected.

The result of this additional selection as shown in rows 245, is that the step 105 where the remaining HSDPA resources are calculated produces a remaining code capacity of 7%, remaining power capacity of 15% and remaining HS-SCCH capacity of 0%.

The scheduler 11 in following step 107, and as shown in row 247, therefore determines that there is at least one resource element which has no remaining capacity, i.e. the HS-SCCH capacity is at its limit. Therefore the method passes to step 109 whereby the scheduler determines if the scheduling allocation is feasible.

With the figures as calculated above both the number of codes used, and the power used by the current selection are within the allowed capacity and therefore the scheduling selection or allocation is feasible. The method proceeds to step 121 where the scheduler stops scheduling further packets for transmission.

In such an example as described above 12 packets are selected to be transmitted from UE1, UE3, UE4, and UE5 over the next TTI. Using code capacity as a measure of spectral efficiency it can be seen that there is an average resource wastage of 7.33%.

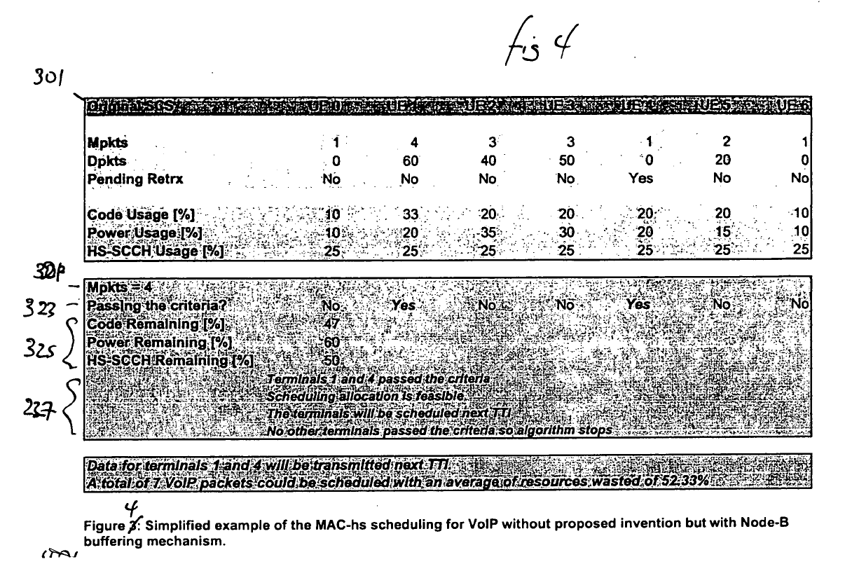

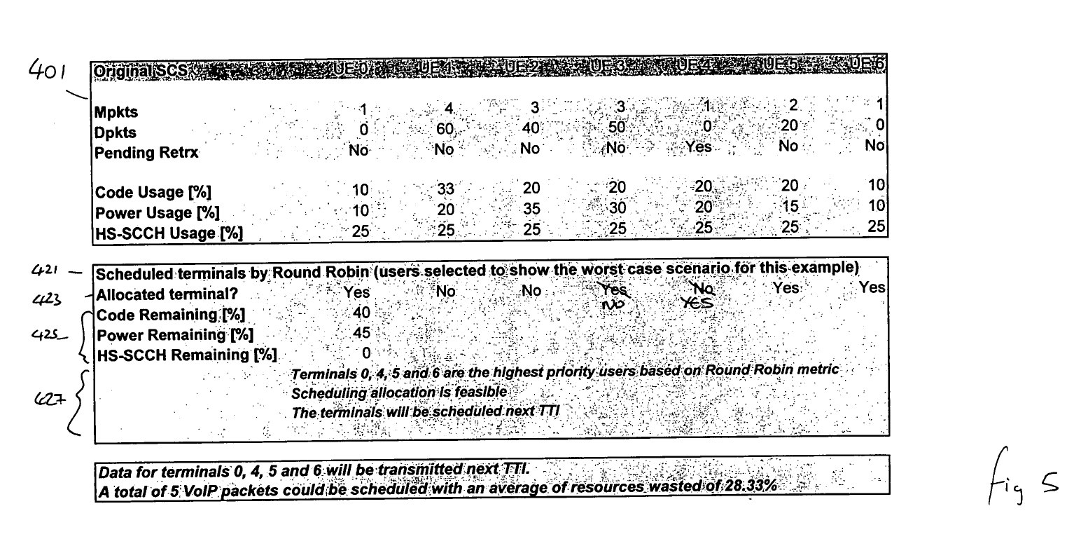

With respect to FIGS. 4 and 5, further tables are shown using the same starting conditions as used in the above examples but using conventional schedulers.

With respect to FIG. 4, the results of the conventional static scheduler are shown. In static schedulers a parameter value is selected and the criteria test is applied once per scheduling in order to produce scheduling that prevents packets from building up in the buffer. The first part 301 of the table establishes the same starting conditions as already discussed with respect to the first part of the table of FIG. 3.

The second part of the table 321 shows parameter value selection, which is the same as the initial parameter selection as disclosed in the first embodiment of the present invention whereby a SCS will be selected if the number of unsent packets is 4 or greater or if any packet in the SCS candidate is a pending retransmission packet.

The results of such a selection as shown in row 323 are that UE1 and UE4 are selected (the same SCS candidates as selected by the first iteration of the example of the first embodiment of the present invention as shown in FIG. 3. As is shown in the rows 325 by adding up the values of the selected columns the remaining code capacity is 47%, the remaining power capacity is 60%, and the remaining HS-SCCH capacity is 50%.

Therefore as shown in rows 327 UE1 and UE4 packets are scheduled for transmission for the next TTI, with a total of 7 packets to be transmitted. However although this method succeeds in transmitting in the next TTI data for UE's which are the ‘oldest’ (the retransmitted packet having been originally transmitted much earlier) it does so with an average wasted resources of 52.33%.

Thus the embodiments of the present invention not only schedule packets so that a low delay tolerant system is catered for but a much better efficiency is produced.

With respect to FIG. 5, the results of the conventional round robin scheduler are shown. In round robin schedulers a SCS candidate is selected if it is next in priority. The first part 401 of the table establishes the same starting conditions as already discussed with respect to the first part of the table of FIGS. 3 and 4.

The second part of the table 421 shows in row 423 which candidates from the SCS list are selected using the round robin scheduling system.

The results of such a selection as shown in row 423 are that UE0, UE4, UE5 and UE6 are selected. As is shown in the rows 325 by adding up the values of the selected columns the remaining code capacity is 40%, the remaining power capacity is 45%, and the remaining HS-SCCH capacity is 0%.

Therefore as shown in rows 427 UE0, UE4, UE5 and UE6 packets are scheduled for transmission for the next TTI, with a total of 5 packets to be transmitted. The average value of resources wasted is 28.33%. This is once again higher than the average resource wastage value produced by the example using method as detailed by the embodiment of the invention. Furthermore this method does not address the need to transmit data where the timing delay or the number of unsent packets may cause delay intolerant services to fail. It can be seen in the above example that the data relating to UE1 is not scheduled for transmission even though it has the largest number of unsent packets and the largest delay.

In further embodiments of the present invention other parameters may be added or substituted from the parameters described above and used to determine the criteria applied to select the SCS candidates. For example one further example of an additional parameter which could be used as a criteria is the usage of a radio resource required such as the percentage of coding, power or HSSCCH usage which will be used to transmit the unsent packets.

In some embodiments of the present invention different selections of parameters are used as criteria to determine the transmission scheduling. Thus for example in one further embodiment only the number of packets parameter (Mpkts) is used to determine which user equipment candidates from the SCS are selected. An embodiment as described above therefore would reduce the number of comparisons carried out by the scheduler allowing the scheduler to be quicker and cheaper to produce.

In other embodiments of the present invention more than one of the compared criteria parameters is dynamically changed between SCS selection iterations. In such embodiments by dynamically changing more than one parameter allows a greater flexibility for the selection criteria and would be useful where the two dynamically changed selection criteria are not linked or correlated.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A packet scheduler for scheduling transmission over a wireless communications high speed downlink connection of at least one data packet addressed to at least one user equipment, the packet scheduler comprising:
a processor configured to determine at least one data packet parameter relating to the at least one data packet addressed to each user equipment, and configured to determine and vary at least one threshold value associated with the at least one data packet parameter;
a comparator configured to perform a first iteration to compare each data packet parameter with an associated threshold value, and configured to perform at least one further iteration to compare each data packet parameter with the associated varied at least one threshold value and to generate an output indicative thereof; and
a data selector configured to select the at least one data packet for scheduling based on the output from the comparator.

2. The packet scheduler as claimed in claim 1, wherein the at least one data packet parameter relating to at least one stored data packet addressed to each user equipment is at least one of:
a number of stored data packets awaiting transmission to each user equipment;
a delay time since receiving first stored packet awaiting transmission to each user equipment; and
whether any of the stored data packets awaiting transmission to each user equipment are pending retransmission data packets.

3. The packet scheduler as claimed in claim 2, wherein the at least one threshold value is at least one of:
a minimum number of stored data packets;
a maximum delay time; and
any pending retransmission data packets.

4. The packet scheduler as claimed in claim 3, wherein the comparator is configured to provide the output if the number of stored data packets awaiting transmission to each user equipment is greater than or equal to the minimum number of stored data packets.

5. The packet scheduler as claimed in claim 4, wherein the comparator is further configured to provide an output if the stored data packets awaiting transmission to each user equipment contain any pending retransmission data packets.

6. The packet scheduler as claimed in claim 3, wherein the processor is configured to vary a value of a minimum number of stored packets.

7. A radio base station, comprising:
a packet scheduler for scheduling transmission over a wireless communications high speed downlink connection of at least one data packet addressed to at least one user equipment, the packet scheduler comprising
a processor configured to determine at least one data packet parameter relating to the at least one data packet addressed to each user equipment, and configured to determine and vary at least one threshold value associated with the at least one data packet parameter,
a comparator configured to perform a first iteration to compare each data packet parameter with an associated threshold value, and configured to perform at least one further iteration to compare each data packet parameter with the associated varied at least one threshold value and to generate an output indicative thereof, and
a data selector configured to select the at least one data packet for scheduling based on the output from the comparator.

8. A radio base station as claimed in claim 7, wherein the wireless communications high speed downlink connection is a wideband code division multiplexing high speed down-link packet access communications (WCDMA HSPDA) system.

9. A radio base station as claimed in claim 7, wherein the data packets are Voice over Internet Protocol (VoIP) packets.

10. A method of performing a packet scheduling transmission over a wireless communications high speed downlink connection of at least one data packet addressed to at least one user equipment, the method comprising:
receiving the at least one data packet addressed to the at least one user equipment;
determining at least one data packet parameter relating to at least one stored data packet addressed to each user equipment;
determining at least one threshold, the at least one threshold associated with the at least one data packet parameter;
varying at least one of the at least one threshold;
comparing in a first iteration each data packet parameter against the associated threshold;
comparing in a further iteration each data packet parameter against the associated varied at least one threshold; and
selecting the at least one data packet for scheduling based on a result of the first or further iteration of the comparing step.

11. The method as claimed in claim 10, wherein the at least one data packet parameter relating to the at least one stored data packet addressed to each user equipment is at least one of:
a number of stored data packets awaiting transmission to each user equipment;
a delay time since receiving first stored packet awaiting transmission to each user equipment; and
whether any of the stored data packets awaiting transmission to each user equipment are pending retransmission data packets.

12. The method as claimed in claim 10, wherein the at least one threshold is at least one of:
a minimum number of stored data packets;
a maximum delay time; and
any pending retransmission data packets.

13. The method as claimed in claim 10, wherein comparing comprises outputting a value indicating the data packets to be selected if a number of stored data packets awaiting transmission to each user equipment is greater than or equal to the minimum number of stored data packets.

14. The method as claimed in claim 13, wherein the first iteration or the further iteration of comparing further comprises the step of outputting a value indicating the data packet to be selected if the at least one stored data packet awaiting transmission to each user equipment contain any pending retransmission data packets.

15. The method as claimed in claim 12, wherein the step of varying at least one of the at least one threshold comprises the step of varying a value of a minimum number of stored packets.

16. The method as claimed in claim 10, wherein the wireless communications high speed downlink connection is a wideband code division multiplexing high speed down-link packet access communications (WCDMA HSPDA) system.

17. The method as claimed in claim 16, wherein the data packets are Voice over Internet Protocol (VOIP) packets.

18. A communications system, comprising:
a packet scheduler for scheduling transmission over a wireless communications high speed downlink connection of at least one data packet addressed to at least one user equipment, the packet scheduler comprising
a processor configured to determine at least one data packet parameter relating to the at least one data packet addressed to each user equipment, and configured to determine and vary at least one threshold value associated with the at least one data packet parameter,
a comparator configured to perform a first iteration to compare each data packet parameter with an associated threshold value, and configured to perform at least one further iteration to compare each data packet parameter with the associated varied at least one threshold value and to generate an output indicative thereof, and
a data selector configured to select the at least one data packet for scheduling based on the output from the comparator.

19. A computer program embodied on a computer readable medium for performing a packet scheduling transmission over a wireless communications high speed downlink connection of at least one data packet addressed to at least one user equipment, the computer program configured to perform the steps of:
receiving the at least one data packet addressed to the at least one user equipment;
determining at least one data packet parameter relating to at least one stored data packet addressed to each user equipment;
determining at least one threshold, the at least one threshold associated with the at least one data packet parameter;
varying at least one of the at least one threshold;
comparing in a first iteration each data packet parameter against the associated threshold;
comparing in a further iteration each data packet parameter against the associated varied at least one threshold; and
selecting the at least one data packet for scheduling based on a result of the first or further iteration of the comparing step.

20. A packet scheduler for scheduling transmission over a wireless communications high speed downlink connection of at least one data packet addressed to at least one user equipment, the packet scheduler comprising:
processor means for determining at least one data packet parameter relating to the at least one data packet addressed to each user equipment, and configured to determine and vary at least one threshold value associated with the at least one data packet parameter;
comparator means for performing a first iteration to compare each data packet parameter with an associated threshold value, and configured to perform at least one further iteration to compare each data packet parameter with the associated varied at least one threshold value and to generate an output indicative thereof; and
data selector means for selecting the at least one data packet for scheduling based on the output from the comparator means.
